(19) United States
(12) Patent Application Publication
(10) Pub. No.: US 2004/0238585 A1
(43) Pub. Date: Dec. 2, 2004

(54) Skateboard pack

(76) Inventor: Peter G. Scarano, Cliffwood, NJ (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(21) Appl. No.: 10/858,711

(22) Filed: Jun. 2, 2004

Related U.S. Application Data
(60) Provisional application No. 60/475,312, filed on Jun. 2, 2003.

(51) Int. Cl. B62M 1/00; A45F 3/02

(52) U.S. Cl. 224/613

(57) ABSTRACT

A skateboard pack, for carrying an assembled skateboard and accessories, has an elongated fabric pouch sized to generally complementarily enclose a conventional skateboard and includes an inner pocket to store other skateboard accessories. The elongated pouch of the skateboard pack also has a closure for opening and closing the elongated pouch to access the interior of the pouch and an adjustable strap equipped with a quick-connect device to allow the pouch to be carried on a back of the user in a generally diagonal orientation.

### CROSS-REFERENCE TO RELATED APPLICATIONS

This non-provisional patent application is based on and claims the benefit of U.S. Provisional Patent Application No. 60/475,312, filed Jun. 2, 2003, the disclosure of which is incorporated herein by reference.

### BACKGROUND OF THE INVENTION

The present invention relates generally to baggage used with sports equipment, and more particularly to a pack used to transport a skateboard.

Backpacks adapted for transporting a skateboard are known in the art. In particular, backpacks suitable for transporting skateboards are available from a variety of commercial sources, and are sold under brand names including “ZITTELI” and “CLIVE”. Such known skateboard backpacks resemble conventional shoulder strap type backpacks in that both the conventional backpacks and those adapted for use with a skateboard comprise two shoulder straps. Thus, a user desiring to transport his or her skateboard and ancillary supplies would typically wear the skateboard backpack in a conventional manner with an arm inserted within each shoulder strap and the skateboard typically centered between the user's shoulders.

A deficiency of the prior art skateboard backpacks becomes evident when a user attempts to ride his or her bicycle while wearing the conventional two shoulder strap skateboard backpack. Specifically, given the length of the skateboard being transported, the user may find that the skateboard extends to a height which interferes with free motion of the user's head while the user is riding his or her bicycle. Alternatively, the skateboard may extend to a sufficiently low height such that the skateboard interferes with motion of a rear wheel of the bicycle.

A need exists, therefore, for a new skateboard pack which allows a user to comfortably wear the skateboard pack to transport a skateboard and ancillary equipment while riding a bicycle.

### BRIEF SUMMARY OF THE INVENTION

Briefly stated, the present invention comprises a skateboard pack for carrying an assembled skateboard and accessories. The skateboard pack includes an elongated fabric pouch having a top end and a bottom end sized to generally complementarily enclose a conventional skateboard. A closure allows for opening and closing the elongated pouch to access an interior of the pouch. A longitudinal strap extends between first and second points on the elongated pouch. The first and second points are selected to allow a user to carry the pouch on a back of the user in a generally diagonal orientation.

In another aspect, the present invention is directed to a combination skateboard pack and skateboard. The combination includes a skateboard having a deck and two pairs of wheels rotatably secured to one side of the deck and an elongated fabric pouch having a top end and a bottom end. The skateboard is removably positioned within the pouch. A closure allows for opening and closing the elongated pouch to access an interior of the pouch. A longitudinal strap extends between first and second points of the elongated pouch. The first and second points are selected to allow a user to carry the pouch on a back of the user in a generally diagonal orientation.

### BRIEF DESCRIPTION OF THE SEVERAL VIEWS OF THE DRAWINGS

The foregoing summary, as well as the following detailed description of a preferred embodiment of the invention, will be better understood when read in conjunction with the appended drawings. For the purpose of illustrating the invention, there is shown in the drawings an embodiment which is presently preferred. It should be understood, however, that the invention is not limited to the precise arrangements and instrumentalities shown.

In the drawings:

FIG. 1 is a perspective view of a skateboard pack in accordance with a preferred embodiment of the present invention;

FIG. 2 is a fragmented view of a side release buckle of a strap of the skateboard pack of FIG. 1;

FIG. 3 is a perspective view of the skateboard pack of FIG. 1 showing the pack in an opened condition to reveal a skateboard contained therein;

FIG. 4 is a partially exploded perspective view of the skateboard pack of FIG. 3;

FIG. 5 is an enlarged upper perspective view of an inner pocket contained within the skateboard pack of FIG. 1; and

FIG. 6 is a rear elevational view of a user wearing the skateboard pack of FIG. 1.

### DETAILED DESCRIPTION OF THE INVENTION

Certain terminology is used in the following description for convenience only and is not limiting. The words “right”, “left”, “lower” and “upper” designate directions in the drawings to which reference is made. The words “inwardly” and “outwardly” refer to directions toward and away from, respectively, the skateboard pack and designated parts thereof. The terminology includes words specifically mentioned, derivatives thereof and words of similar import.

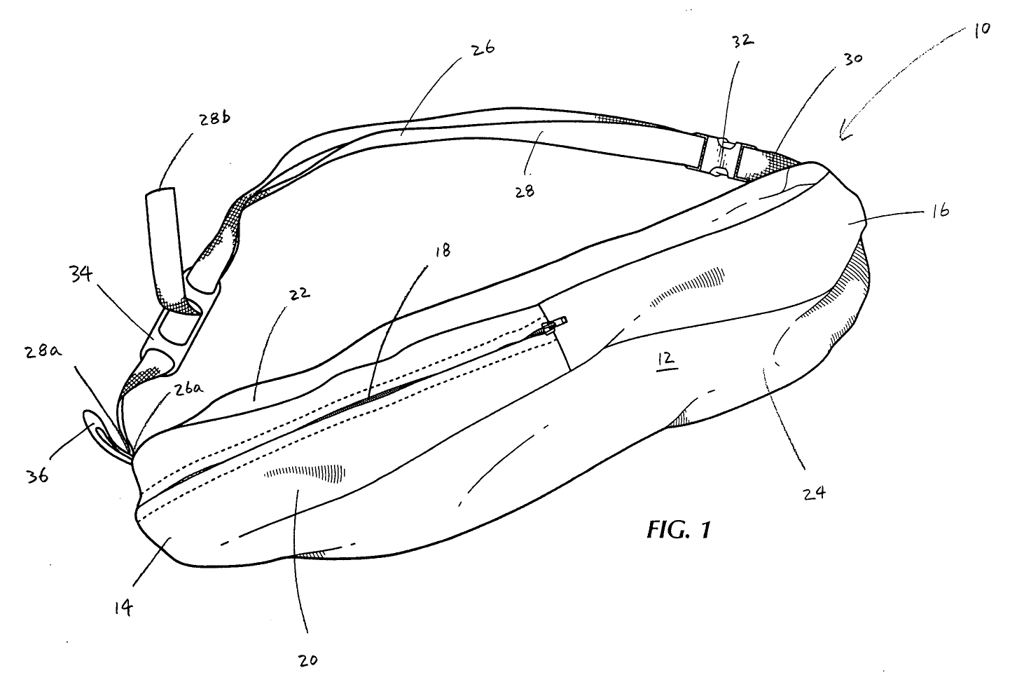

Referring to the drawings, wherein like reference numerals are used to designate like components throughout the figures, there is shown in FIGS. 1-6 in accordance with a preferred embodiment of the present invention a skateboard pack assembly, generally designated 10, suitable for transporting a skateboard and ancillary equipment. The skateboard pack 10 comprises an elongated fabric pouch 12 having a top end 14 and a bottom end 16, a closure 18 and a longitudinal strap 26 having a length extending between first and second points 26a, 26b on the elongated pouch 12. The pouch 12 further includes an inner pocket 38.

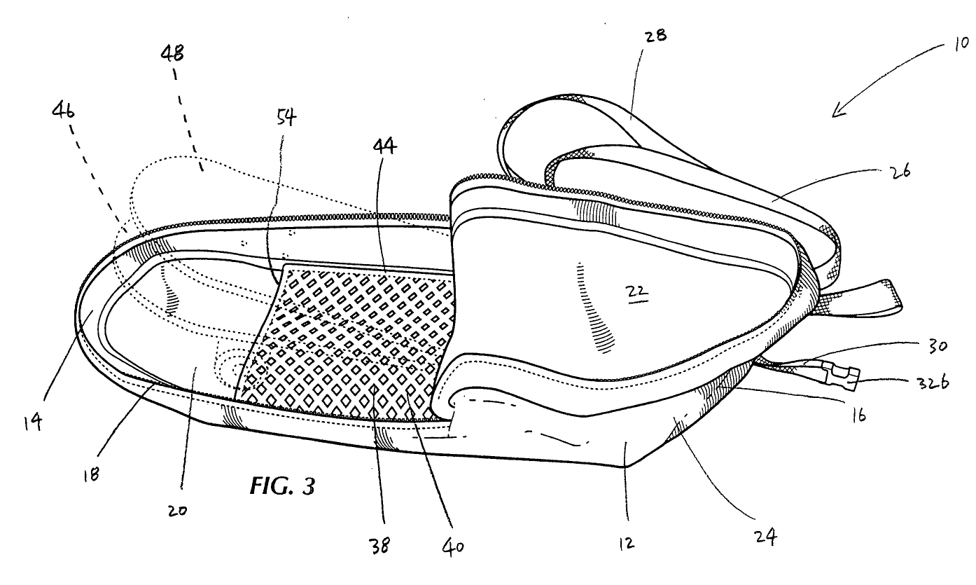

FIG. 1 illustrates the skateboard pack 10 in a closed configuration. In a preferred embodiment, the elongated pouch 12 is dimensioned to enclose a conventional skateboard 46 (see FIG. 3) and a spare skateboard deck 48 with lengths in the range of 24 to 40 inches. The elongated pouch 12 is preferably fabricated from a durable and weather-resistant fabric such as dernier polyester using conventional sewing techniques. From this disclosure, one of ordinary skill in the art would recognize that other fabrics such as nylon, cotton or blends thereof could be substituted. The artisan would further recognize that the elongated pouch 12 (as well as the strap 26) could be provided with reflective portions (not illustrated) for high visibility in low light conditions.

In the preferred embodiment, the closure 18 is a zipper. The closure 18 connects a front flap 20 and a rear flap 22 extending from a point intermediate the top end 14 and the bottom end 16 to the top end 14. The elongated pouch 12 includes a bottom pouch 24 for receiving approximately one half the length of the skateboard 46. The bottom pouch 24 is formed between the front and rear flaps 20, 22 and the bottom end 16. One of ordinary skill in the art would recognize from this disclosure that the closure 18 could have other forms, for example, the top end 14 of the elongated pouch 12 could be open with a string or rope secured to the circumference of the top end 14 where the string or rope is adjusted to open and close the top end 14.

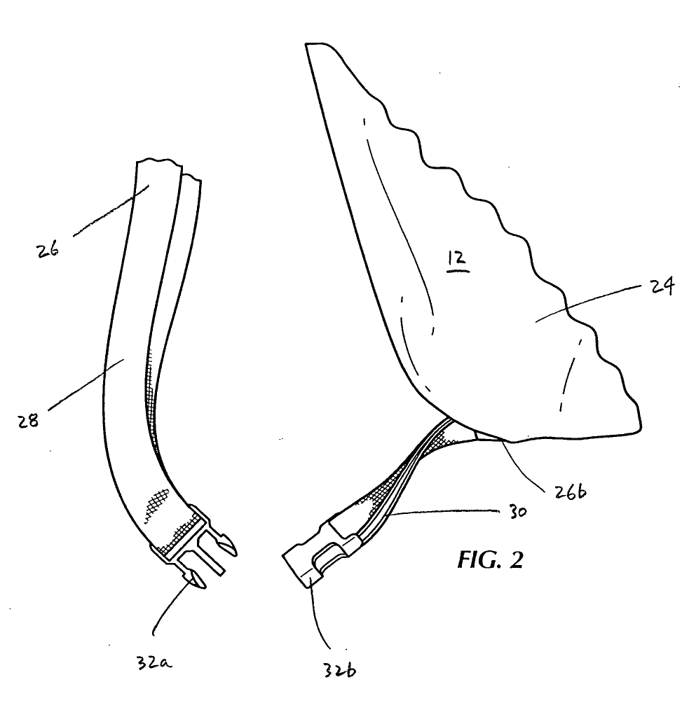

Referring to FIGS. 1 and 2, the strap 26 extends between a first point 26a and a second point 26b on the elongated pouch 12. In a preferred embodiment, the strap 26 is attached at the top and bottom ends 14, 16 of the elongated pouch 12, and includes a top portion 28 of the strap 26, a bottom portion 30 of the strap 26, a quick-connect device 32 and a shoulder pad 34. As illustrated in FIG. 2, the quick-connect device 32 comprises a male portion 32a and a female portion 32b. The male and female portions 32a, 32b are releasably connectable by flexible tongs on the male portion 32a which are received within the female portion 32b. One of ordinary skill in the art would recognize that other styles of buckles or some other type of attachment device could be substituted or that the buckle could be omitted without departing from the spirit and scope of the invention.

A first length of webbing forms a top portion 28 of the strap 26 and is attached at a first end 28a to the rear flap 22 at the top end 14. The top portion 28 passes through the shoulder pad 34 and also loops through the male portion 32a of the quick-connect device 32. The top portion 28 loops through the male portion 32a in a manner that allows the top portion 28 to be readily moved with respect to the male portion 32a so long as the top portion 28 is not taut and generally aligned with respect to the male portion 32a. When the top portion 28 is taut and generally aligned with respect to the male portion 32a, the top portion 28 tends to lock in place with respect to the male portion 32a. Thus, the length of the strap 26 may be adjusted by repositioning the male portion 32a along the top portion 28. A second free end 28b of the top portion 28 passes through the shoulder pad 34. Further, a second length of webbing is attached at each opposing end to the bottom pouch 24 at the bottom end 16, thus forming the bottom portion 30 of the strap 26. The female portion 32b of the quick-connect device 32 is attached to the elongated pouch 12 by the bottom portion 30. A third length of webbing forms a loop 36 adjacent the top portion 28 at the top end 14 of the elongated pouch 12. The top portion 28, bottom portion 30 and loop 36 are preferably fabricated nylon webbing, but from this disclosure the one of ordinary skill in the art would recognize that other durable and weather-resistant webbing materials such as polyester could be substituted. In addition, the artisan would recognize that the strap 26 could be attached at different points on the elongated pouch 12 to maintain a diagonal orientation of the skateboard pack 10 on a user's 50 back. The artisan would further recognize that the top portion 28 and the bottom portion 30 could switch positions without departing from the scope and spirit of the present invention.

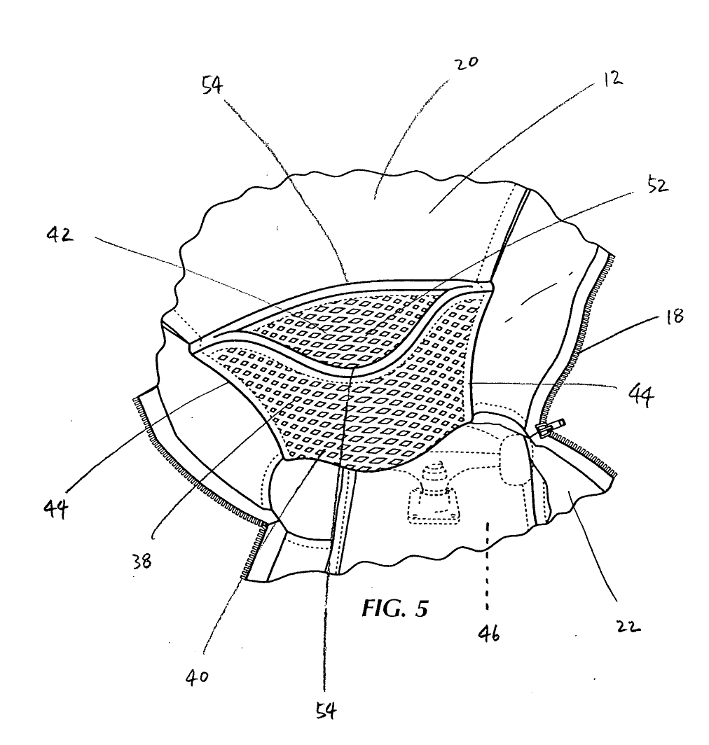

Referring to FIG. 5, in the preferred embodiment, the inner pocket 38 is formed by a front mesh panel 40 and an intermediate rear mesh panel 42. The front and rear mesh panels 40, 42 are secured together along their respective bottom edges, while opposing side edges 44 of the front and mesh panels 40, 42 are secured to the front flap 20. An opening 52 is formed between the top edges 54 of the front and rear mesh panels 40, 42. The inner pocket 38 is preferably sized to receive at least a second set of skateboard wheels (not shown), but can be used to store anything suitably sized, such as repair tools. The front and rear mesh panels 40, 42 are fabricated from a nylon material. One of ordinary skill in the art would recognize from this disclosure that numerous other suitably durable mesh and non-mesh type materials, for example cotton, polyester or blends thereof, could be substituted for the mesh panels 40, 42. The artisan would further recognize that a second zipper (not shown) could be provided in the front flap 20 to allow access to the inner pouch 38 without opening the primary zipper 18.

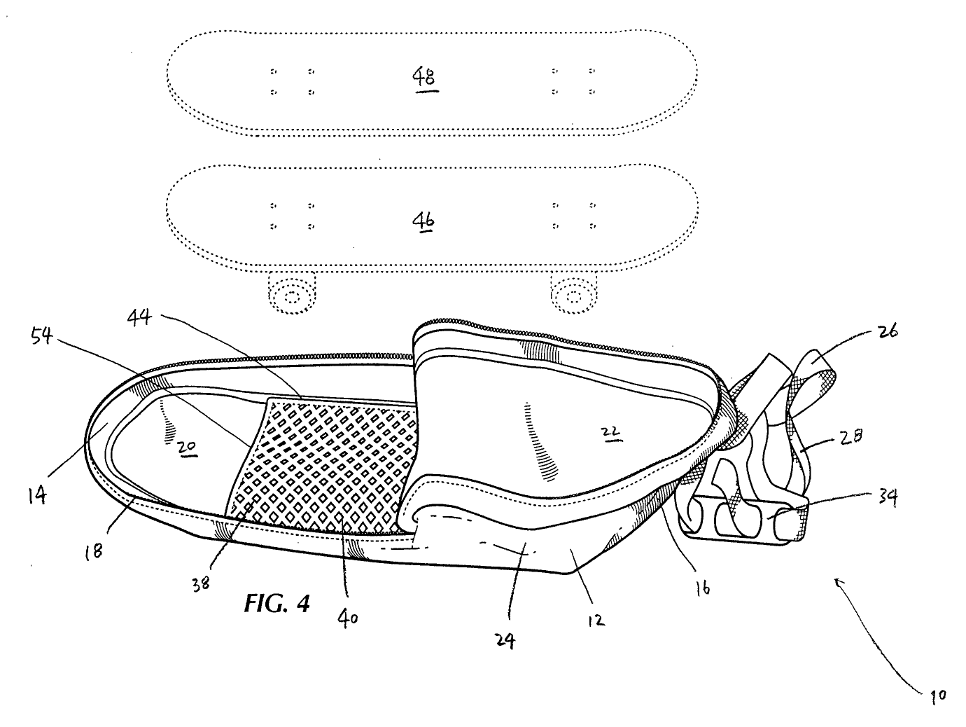

In operation, the skateboard pack's 10 zipper 18 is unzipped, allowing the front flap 20 to separate from the rear flap 22 into an open configuration as illustrated in FIGS. 3-5. When the skateboard 46 and spare skateboard deck 48 are removed from the elongated pouch 12, as shown in FIG. 4, an inner pocket 38 attached to the front flap 20 is readily accessible. Smaller ancillary equipment, for example spare skateboard wheels (not illustrated), spare tools (not illustrated) or other sundries may be inserted within the inner pocket 38. With the skateboard pack 10 in the open configuration, the skateboard 46 and the spare skateboard deck 48 can be disposed within the elongated pouch 12.

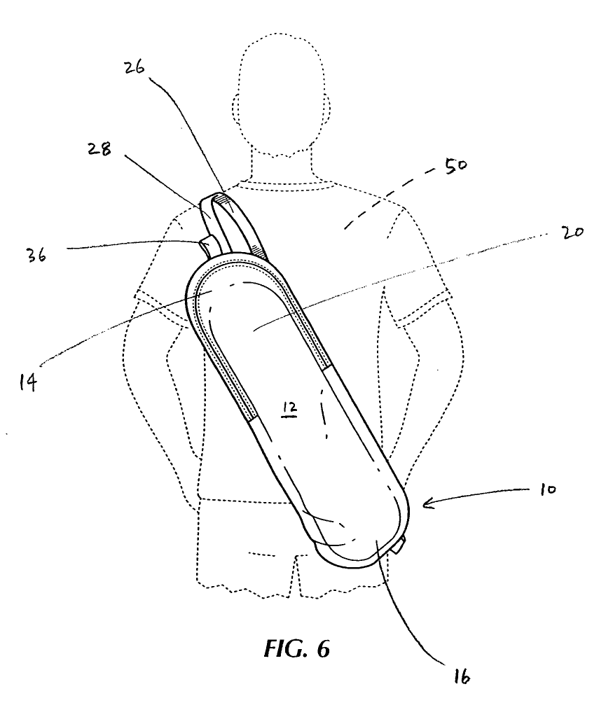

After closing the zipper, the user 50 preferably proceeds to place the skateboard pack assembly 10 diagonally across his or her torso, as illustrated in FIG. 6, with the strap 26 disposed diagonally across a front portion of the user's torso and the elongated pouch 12 disposed diagonally across the user's back. If needed, the user 50 may adjust the length of the strap 26 to optimize comfort. With the skateboard pack 10 thus diagonally oriented, upper and lower ends of the skateboard 46 are less likely to interfere with free movement of the user's head and the rear bicycle wheel, respectively, while the user is riding his or her bicycle (not shown).

From the foregoing it can be seen that the present invention comprises a skateboard pack 10 having a single carrying strap 26 and which can be worn by a user in a diagonally-oriented manner as to improve comfort of the user as compared to known skateboard backpacks when the skateboard pack 10 is worn while riding a bicycle. It will be appreciated by those of ordinary skill in the art that modifications may be made to the above described embodiment without departing from the scope and spirit of the present invention.

I claim:

1. A skateboard pack for carrying an assembled skateboard and accessories therefor, the skateboard pack comprising:
an elongated fabric pouch sized to generally complementarily enclose a conventional skateboard, said elongated pouch having a top end and a bottom end;
a closure for opening and closing said elongated pouch to access an interior of the pouch; and
a longitudinal strap having a length extending between first and second points on said elongated pouch, said length, first point and second point being selected to allow a user to carry the pouch on a back of the user in a generally diagonal orientation.

2. A skateboard pack as set forth in claim 1, wherein the elongated pouch is constructed of a material selected from the group consisting of polyester, nylon, cotton and blends thereof.

3. A skateboard pack as set forth in claim 1, wherein the closure for opening and closing the elongated pouch is a zipper.

4. A skateboard pack as set forth in claim 1, wherein the strap for carrying the elongated pouch includes a quick connect device releasably securing at least one of top and bottom portions of the strap.

5. A skateboard pack as set forth in claim 1, wherein the pouch further includes an inner pocket for receiving skateboard accessories.

6. A skateboard pack as set forth in claim 1, wherein the elongated pouch has a length in the range of 24 to 40 inches.

7. A combination skateboard pack and skateboard, the combination comprising:
a skateboard including a deck and two pairs of wheels rotatably secured to one side of the deck;
an elongated fabric pouch having a top end and a bottom end, the skateboard being removably positioned within the pouch;
a closure for opening and closing said elongated pouch to access an interior of the pouch; and
a longitudinal strap extending between first and second points on said elongated pouch, said length, first point and second point being selected to allow a user to carry the pouch on a back of the user in a generally diagonal orientation.

8. A combination of claim 7, wherein the elongated pouch is constructed of a material selected from the group consisting of polyester, nylon, cotton and blends thereof.

9. A combination of claim 7, wherein the closure for opening and closing the elongated pouch is a zipper.

10. A combination of claim 7, wherein the strap for carrying the elongated pouch includes a quick connect device releasably securing at least one of top and bottom portions of the strap.

11. A combination of claim 7, wherein the pouch further includes an inner pocket for receiving skateboard accessories.

12. A combination of claim 7, further comprising skateboard accessories positioned within the pouch.

13. A combination of claim 7, wherein the elongated pouch has a length in the range of 24 to 40 inches.

14. A combination of claim 7, wherein the elongated pouch is sized to generally complementarily enclose the skateboard.
